(19) United States
(12) Patent Application Publication
(10) Pub. No.: US 2026/0361697 A1
(43) Pub. Date: Nov. 12, 2026

(54) ON DEVICE GENERATION OF PRIVACY PRESERVING INTEREST CAPSULES FOR PERSONALIZED DIGITAL CONTENT SELECTION

(71) Applicant: David Gerken, Redondo Beach, CA (US)

(72) Inventor: David Gerken, Redondo Beach, CA (US)

(21) Appl. No.: 19/201,816

(22) Filed: May 7, 2025

(51) Int. Cl. H04L 9/40

(52) U.S. Cl. CPC H04L 63/0428

(57) ABSTRACT

A client device executes a machine learning model locally to transform user data into a representation vector. The vector is transformed using a multi-stage pipeline comprising dimensionality reduction, sparsification, differential privacy noise, fixed-precision quantization, and authenticated encryption to form a compact interest capsule. The capsule is transmitted to a content selection service, maintaining privacy through cryptographic protection, automatic expiration, and device-specific pseudorandom projection. Because raw user data never leaves the device, the approach enables high-relevance personalization while complying with privacy regulations. Interest capsules refresh regularly, automatically expire, and may be used for local or server-side content ranking. Server components verify on-device origin through attestation and delete capsules immediately after use. Applications include digital advertising, media recommendations, news personalization, and other forms of personalized digital content delivery. A system and non-transitory medium performing the method are also disclosed.

### TECHNICAL FIELD

The present disclosure relates generally to personalized digital content technology and, more particularly, to systems and methods for generating privacy-preserving user-interest representations entirely on a client device for use in selecting or ranking digital content, including but not limited to advertisements, media recommendations, news content, and personalized information.

### BACKGROUND

Behavioral targeting of digital content, particularly advertisements, has historically depended upon third-party cookies, mobile-advertising identifiers (MAIDs), and other trackable user identifiers transmitted to remote servers. Recent and imminent regulatory changes severely limit these identifiers, including:
The European Union's General Data Protection Regulation (GDPR) and Digital Markets Act (DMA), with the latter's implementation timeline accelerating in 2024;
The California Consumer Privacy Act (CCPA) and similar legislation in Virginia, Colorado, and other U.S. states;
Brazil's Lei Geral de Proteção de Dados (LGPD) and similar frameworks emerging in India, Australia, and other jurisdictions.

Platform-level privacy measures have similarly restricted user tracking capabilities:
Apple's App Tracking Transparency framework on iOS, which has seen opt-in rates below 25% since its 2021 introduction;
Google Chrome's announced deprecation of third-party cookies, scheduled for completion by Q4 2024;
Mozilla Firefox and Apple Safari's Intelligent Tracking Prevention (ITP) mechanisms.

Traditional server-side user-profiling techniques export personally identifiable information (PII), thereby heightening compliance risk under these regulations and eroding user trust. According to recent industry surveys, over 78% of users report concerns about how their data is collected and used for targeted content delivery.

There is therefore a critical need for technical solutions that preserve or improve content relevance and personalization without transmitting raw user data off the user's device, while providing rigorous privacy guarantees and maintaining compatibility with evolving regulatory requirements.

### SUMMARY OF THE INVENTION

In one aspect, a computer-implemented method executed by a client device collects user data, processes the user data with a machine learning model executed entirely on the client device to generate a representation vector, transforms the representation vector into a privacy-preserving interest capsule, transmits the interest capsule to a content selection service, and receives personalized digital content selected based on the interest capsule without transmitting the raw user data off-device.

Another aspect provides a non-transitory computer-readable medium storing instructions to perform the foregoing method, and yet another aspect provides a system comprising a client device and a content selection server that cooperate to perform the method.

The interest capsule, defined as a self-contained, privacy-preserving vector representation having embedded expiry metadata, maintains user privacy through multiple technical safeguards including differential privacy guarantees, limited data representation, authenticated encryption with associated data (AEAD), automatic expiration, and user-initiated revocation capabilities. The technology enables high-quality personalization while ensuring that sensitive user information remains exclusively on the user's device.

### BRIEF DESCRIPTION OF THE DRAWINGS

FIG. 1 is a block diagram illustrating a system architecture in which the disclosed interest-capsule engine operates.

FIG. 2 is a flowchart depicting client-side data-collection and tokenization.

FIG. 3 is a flowchart depicting interest capsule generation, differential-privacy processing, encryption, and transmission.

FIG. 4 is a schematic diagram of an exemplary interest-capsule data structure.

FIG. 5 is a diagram illustrating local and server content-selection paths utilizing the interest capsule.

FIG. 6 is a diagram illustrating the federated learning architecture for model parameter updates.

FIG. 7 is a flowchart depicting error handling and fallback mechanisms.

FIG. 8 is a diagram illustrating the hardware acceleration components utilized for on-device processing.

FIG. 9 is a diagram illustrating user control interfaces for capsule management.

### DETAILED DESCRIPTION

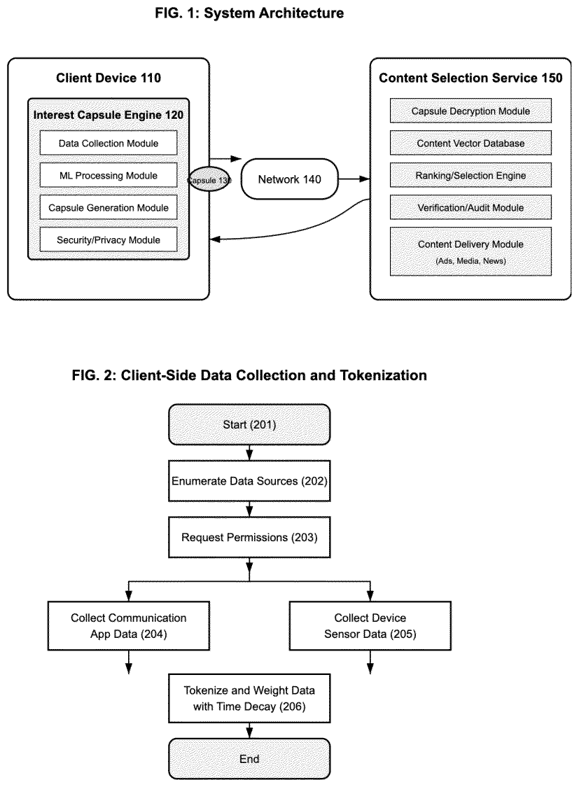

### System Overview (FIG. 1)

System 100 comprises at least one client device 110 (e.g., smartphone, tablet, smart-TV, wearable, laptop, desktop computer, or in-vehicle infotainment system) executing an interest-capsule engine 120 and at least one content-selection service 150 connected via a network 140. The engine maintains strict data-locality, never transmitting raw user data. The content-selection service 150 may comprise an advertising demand-side platform (DSP), a media recommendation system, a news aggregator, or any other digital service that provides personalized content to users.

### Client-side Data Collection (FIG. 2; Steps 201-206)

The engine enumerates configurable data sources from the following categories:
1. Communication data: Email headers (not content), messaging app metadata, social media engagement metrics;
2. Application usage: Web browsing titles, in-app events, feature engagement patterns, dwell time;
3. Media interaction: Content consumption patterns, media metadata (not including detailed content), engagement metrics;
4. Device data: Photo metadata (not image content), calendar events (excluding details), location summaries (not precise coordinates);
5. Wellness information: Health summaries, activity patterns, sleep metrics (where permission is explicitly granted);
6. Sensor events: Accelerometer patterns, barometric readings, ambient light levels (with privacy filtering).

Each event E=<token, timestamp, weight, source_category> is subject to:
Exponential time-decay λ to prioritize recent interests
Categorical weighting α(c) to balance influence across data sources
Explicit user preference adjustments β
Storage exclusively in volatile memory during capsule-generation

The system implements a cold-start handling mechanism for new users or devices with limited historical data, utilizing a combination of explicitly provided preferences, broad category-level defaults, and progressive personalization as user data accumulates.

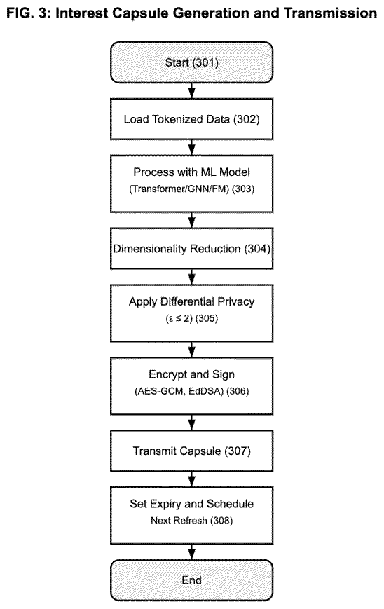

### Machine Learning Processing (FIG. 3; Steps 301-303)

The client device processes collected data using one of several machine learning approaches:
1. Transformer Model: A distilled transformer converts weighted tokens into a d-dimensional embedding vector v(u). The transformer architecture enables contextual understanding of user interests across multiple domains.
2. Graph Neural Network: For applications emphasizing relationship patterns between interests, a lightweight graph neural network (GNN) may be utilized, consuming limited RAM while capturing complex interest relationships.
3. Factorization Machine: For applications prioritizing computational efficiency, a factorization machine approach provides rapid processing with limited RAM requirements.
4. Hybrid Models: Combinations of the above approaches may be employed for specific application contexts.

Model parameters θ are updated via federated learning without centralizing raw user data, as detailed in FIG. 6. The federated learning coordinator aggregates gradient updates across participating devices using secure aggregation protocols to prevent individual device contributions from being identified.

### Hardware Acceleration (FIG. 8)

The processing pipeline leverages device-specific hardware acceleration where available:
1. Neural Processing Units (NPUs): On devices equipped with dedicated neural processors (e.g., Apple Neural Engine, Google Tensor Processing Unit, Qualcomm AI Engine), the system offloads appropriate machine learning operations to achieve 3-5x speedup over CPU-only processing.
2. Graphics Processing Units (GPUs): for devices without dedicated NPUS, Shader cores on integrated or discrete GPUs provide parallel processing capabilities with 2-3x performance improvement.
3. Secure Enclaves: On supported devices (e.g., Apple Secure Enclave, ARM TrustZone, Intel SGX), sensitive operations may execute within hardware-protected memory regions that prevent access even by the operating system.
4. Low-Power Accelerators: For battery-constrained devices, specialized low-power accelerators may be utilized for specific operations to minimize energy consumption.

The hardware acceleration subsystem implements dynamic capability detection and workload distribution to optimize performance across heterogeneous computing environments. The system dynamically routes tensor operations to a neural-processing unit when one is present, otherwise to a GPU, otherwise to a CPU, ensuring optimal performance across diverse hardware configurations.

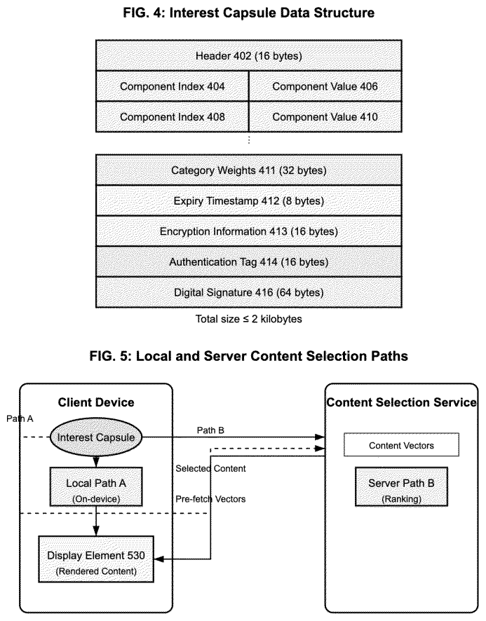

### Capsule Construction and Privacy Preservation (FIG. 3; Steps 304-306 & FIG. 4)

The representation vector undergoes multiple transformations to create the privacy-preserving interest capsule through a multi-stage capsule pipeline. The transforming comprises, in the following ordered sequence:
1. Dimensionality Reduction: The initial high-dimensional vector (d=128-768 depending on model configuration) is transformed using principal component analysis, singular value decomposition, or autoencoder techniques to reduce dimensionality while preserving information content.
2. Sparsification: The system retains no more than K highest-magnitude components (default K=64, configurable between 32-128), forming a sparse representation with indices and values stored as component pairs.
3. Differential Privacy: Calibrated Laplace or Gaussian noise is added to achieve ε-differential privacy (ε≤2, δ≤10-6), providing formal mathematical guarantees against inference attacks. The privacy parameters are dynamically adjusted based on capsule refresh frequency and sensitivity analysis.
4. Fixed-Precision Quantization: The resulting values are quantized to 8-bit precision; alternatively, the system may employ 4-bit or 16-bit quantization based on precision requirements and size constraints.
5. Authenticated Encryption: The system applies authenticated encryption with associated data (AEAD) that embeds a time-to-live field and cryptographic key identifier in the ciphertext header.

Additionally, the transforming further comprises projecting the vector into a pseudorandom sub-space defined by a secret key unique to the client device instance, adding a cryptographic barrier to potential reconstruction attempts.

The resulting interest capsule has a payload size not exceeding 2 kilobytes, contributing to bandwidth efficiency and processing speed.

The complete capsule structure comprises:
Header 402 (metadata, version, creation timestamp)
Component pairs 404/406-408/410 (indices and values)
Category weights 411 (relative importance of interest categories)
Expiry timestamp 412 (automatic invalidation)
Encryption information 413 (key identifier, algorithm parameters)
Authentication tag 414 (AES-GCM or ChaCha20-Poly1305)
Digital signature 416 (EdDSA or ECDSA)

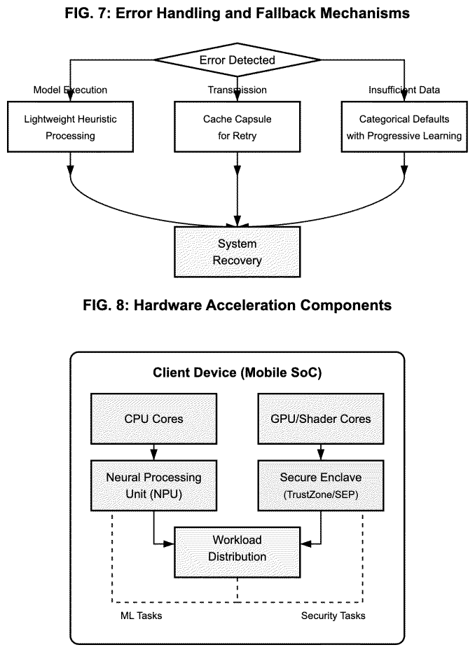

### Error Handling and Fallback Mechanisms (FIG. 7)

The system implements comprehensive error handling:
1. Model Execution Failures: If machine learning model execution fails due to resource constraints or other issues, the system falls back to lightweight heuristic-based processing.
2. Insufficient Data: For users with insufficient data for reliable interest inference, the system employs categorical defaults with progressive personalization.
3. Transmission Failures: If capsule transmission fails, the system caches the capsule locally for later retransmission and provides non-personalized content in the interim.
4. Cryptographic Failures: Key rotation and recovery mechanisms ensure resilience against cryptographic failures.
5. Version Compatibility: Forward and backward compatibility mechanisms handle version mismatches between client and server components.

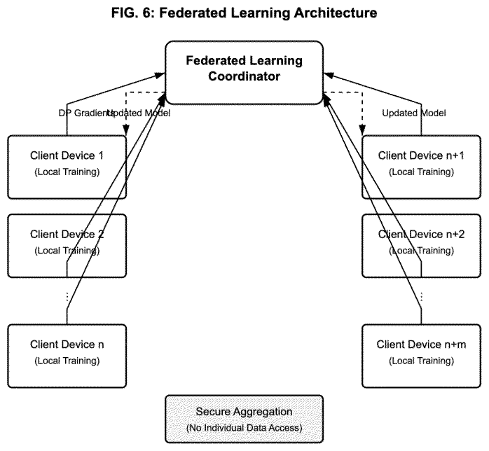

### Transmission and Content Selection (FIG. 3; Step 307; FIG. 5)

Capsule 130 is transmitted over TLS 1.3 (or subsequent versions) with certificate pinning and additional transport security measures to the content selection service 150. Two primary selection paths are supported:

### Local Path a:

1. The client device pre-fetches candidate content vectors from service 150
2. Local ranking occurs using configurable similarity metrics:
Cosine similarity (default)
Euclidean distance
Mahalanobis distance
Learned metric functions
3. Content is selected and rendered at display element 530 without transmitting the interest capsule off-device

### Server Path B:

1. The client transmits the encrypted capsule to service 150
2. The service decrypts the capsule using authorized keys
3. Candidate content is ranked according to similarity metrics
4. The service returns content identifiers or complete content
5. The service deletes the capsule immediately after use (≤60 seconds, typically <10 ms)
6. Selected content is rendered at display element 530

The system dynamically selects between paths based on a heuristic that jointly considers (i) instantaneous network latency, (ii) battery reserve, and (iii) device thermal state, optimizing for both user experience and device resources.

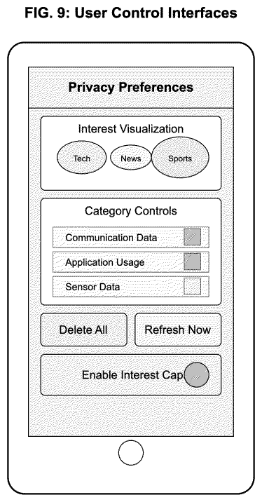

### User Controls and Transparency (FIG. 9)

The system provides comprehensive user controls:
1. Interest Visualization: Users can view a human-readable representation of their interest capsule
2. Category Controls: Users can enable/disable specific interest categories
3. Explicit Preferences: Users can manually adjust interest weights
4. Deletion Controls: One-tap capsule deletion and regeneration
5. Global Opt-Out: Users can disable interest capsule generation entirely

The interface provides transparency without exposing raw user data or technical implementation details that might compromise security. The system displays on the client device a human-readable breakdown of the interest capsule and accepts user edits that immediately alter subsequent capsules.

Refresh, Rotation, and Revocation (step 308)

Capsules incorporate multiple temporal security mechanisms:
1. Periodic Refresh: Capsules refresh at a cadence shorter than 24 hours (default 24 h, configurable between 1h-7d)
2. Key Rotation: Cryptographic keys rotate with each refresh; additional emergency rotation capability exists for security incidents
3. Time-To-Live (TTL): Capsules expire after a configurable period (default 7d, maximum 30d)
4. Revocation: User-initiated or automatic revocation immediately invalidates all active capsules
5. Attestation: The system generates cryptographic proof that capsules were generated on-device without server-side processing of raw user data, transmitting with the capsule a hardware-rooted attestation token asserting that no raw user data left secure memory during capsule generation

Upon revocation, all capsule-related data is securely erased from both client and server storage.

### Security Measures Against Attacks

The system implements multiple defenses against potential attacks:
1. Adversarial Examples: Input sanitization and robust model architecture mitigate adversarial inputs
2. Model Inversion: Differential privacy guarantees prevent reconstruction of user data
3. Linkability Attacks: Regularly rotating pseudonymous identifiers prevent cross-site tracking
4. Side-Channel Attacks: Constant-time cryptographic operations and memory access patterns
5. Replay Attacks: Timestamp validation and nonce mechanisms

Security measures undergo regular third-party auditing and penetration testing.

### Applications Beyond Advertising

While digital advertising represents a primary application, the interest capsule architecture supports multiple personalization scenarios:
1. Media Recommendations: Personalized content feeds, video suggestions, music playlists
2. News Personalization: Topic prioritization, source diversity balancing
3. E-commerce: Product recommendations, search result ranking
4. Educational Content: Learning material adaptation, difficulty scaling
5. Productivity Applications: Feature highlighting, workflow optimization
6. Gaming: Content adaptation, difficulty adjustment, matchmaking

Each application domain may utilize domain-specific models while maintaining the core privacy-preserving architecture.

### Cold-start Bootstrap

In the absence of sufficient historical data, the client populates an initial interest capsule from explicit user-provided preferences. This approach enables immediate personalization for new users while maintaining privacy guarantees.

### Federated Learning Implementation (FIG. 6)

The system maintains two separate communication channels:
1. Capsule Channel: For transmitting interest capsules to content selection services
2. Gradient Update Channel: For federated learning model improvements
The system transmits gradient updates derived from local training of the machine-learning model via secure aggregation, wherein the gradient-update channel is cryptographically distinct from the interest-capsule channel. This separation provides additional security and privacy guarantees.

The federated learning process includes:
1. Secure Aggregation Protocol: Detailed cryptographic protocol ensuring that individual gradient contributions cannot be attributed to specific devices even by the aggregation server.
2. Differential Privacy in Training: Noise addition to gradient updates providing ε-differential privacy guarantees for the training process itself.
3. Communication Efficiency: Compression techniques reducing bandwidth requirements for gradient exchange by 60-80%.
4. Participant Selection: Stratified sampling ensuring representative device participation without biasing model updates.
5. Convergence Guarantees: Mathematical analysis of convergence properties under non-IID (Independent and Identically Distributed) data conditions typical in federated settings.

### Alternative Embodiments

Alternative Compression Techniques:
1. Product Quantization: Instead of simple magnitude-based component selection, product quantization partitions the vector space into subspaces and applies vector quantization within each subspace.
2. Bloom Filters: For applications prioritizing set membership over numerical representation, interest categories may be encoded in space-efficient Bloom filters.
3. Locality-Sensitive Hashing (LSH): For applications requiring similarity preservation in compressed representations, LSH functions map similar vectors to the same buckets with high probability. This enables approximate nearest-neighbor search without decompressing the full representation.
4. Sparse Coding: Beyond simple top-K component selection, learned sparse coding dictionaries can represent interests more efficiently.

Alternative Machine Learning Architectures:
1. Mixture of Experts (MoE): For handling diverse interest domains, a gated mixture of specialized models activates only relevant expert components based on input characteristics, reducing computational requirements.
2. Contrastive Learning: Self-supervised contrastive objectives can improve representation quality without labeled data, particularly beneficial during cold-start periods.
3. Multi-Task Learning: Simultaneously optimizing for multiple objectives (e.g., content relevance, diversity, user satisfaction) can produce more balanced representations.
4. Attention Mechanisms: Beyond standard transformers, specialized attention architectures can capture temporal patterns in user interests with improved efficiency.

Implementation in Various Contexts:
1. Mobile Web: JavaScript implementation with IndexedDB for local storage and WebAssembly for computational efficiency.
2. Progressive Web Apps (pwas): Service Worker Integration Enabling Offline operation and background refresh cycles.
3. Native Mobile Applications: Language-specific implementations (Swift/Kotlin) with direct hardware acceleration access.
4. Connected TV (CTV): Lightweight implementation for resource-constrained environments, with simplified models and extended refresh intervals.
5. Digital Out-of-Home (DOOH): Anonymous aggregate capsules derived from device-specific instances, with additional k-anonymity guarantees.
6. In-Vehicle Infotainment: Integration with automotive-grade hardware security modules and driver profile management.

Hardware Security Integration:
1. Secure Enclaves: Detailed integration procedures for:
Apple Secure Enclave on iOS/macOS
ARM TrustZone on Android/Windows
Intel SGX on compatible x86 platforms
2. Hardware Security Modules (HSMs): Key management procedures for enterprise deployment scenarios.
3. Trusted Execution Environments (tees): Attestation Mechanisms Proving on-device processing to remote services.
4. Hardware-accelerated Cryptography: Utilization of Aes-ni, Sha-ni, and

platform-specific cryptographic accelerators.

1. A computer-implemented method for delivering personalized digital content, comprising:
(a) collecting, by a client device, user data;
(b) processing the user data with a machine learning model executed on the client device to generate a representation vector;
(c) transforming the representation vector into a privacy-preserving interest capsule through a transformation process that protects user privacy while preserving utility for content selection;
(d) transmitting the interest capsule to a content selection service; and
(e) receiving content selected based at least in part on the interest capsule,
wherein the interest capsule includes validity metadata, and
wherein the transforming comprises applying a device-specific cryptographic operation.

2. A computer-implemented method comprising:
(a) receiving, by a content-selection service, an encrypted interest capsule having validity metadata;
(b) decrypting the capsule, verifying its origin, and computing a similarity score between the capsule and a plurality of candidate content vectors;
(c) selecting digital content based on the similarity score; and
(d) deleting the interest capsule after content selection and within a security-defined interval.

3. A system for privacy-preserving personalized content delivery, comprising:
(a) a client device including a processor and memory storing instructions configured to:
(i) collect user data;
(ii) process the user data with a machine learning model to generate a representation vector;
(iii) transform the representation vector into a privacy-preserving interest capsule through a transformation process; and
(iv) transmit the interest capsule to a content selection server; and
(b) the content selection server configured to select digital content based at least in part on the interest capsule and provide the selected digital content to the client device.

4. The method of claim 1, wherein the transformation process comprises, in sequence:
(i) dimensionality reduction of the representation vector;
(ii) sparsification by retaining a subset of vector components;
(iii) application of calibrated differential-privacy noise;
(iv) fixed-precision quantization; and
(v) authenticated encryption that embeds validity metadata.

5. The method of claim 1, wherein the resulting interest capsule has a payload size optimized for efficient network transmission.

6. The method of claim 1, wherein the machine learning model is executed entirely on the client device without transmitting the user data to external servers.

7. The method of claim 1, wherein the machine learning model comprises at least one of: a transformer, a graph neural network, a factorization machine, a convolutional neural network, or a recurrent neural network.

8. The method of claim 1, wherein processing the user data is accelerated using at least one of: a neural processing unit (NPU), a graphics processing unit (GPU), or a secure enclave, and wherein executing the machine-learning model comprises dynamically routing tensor operations to a neural-processing unit when one is present, otherwise to a GPU, otherwise to a CPU.

9. The method of claim 1, wherein the client selects between local ranking and server ranking based on a heuristic that considers network conditions and device resources.

10. The method of claim 1, further comprising refreshing the interest capsule periodically and rotating cryptographic keys with each refresh, and further comprising deleting the user data from memory of the client device after generating the interest capsule.

11. The method of claim 2, wherein the content selection service deletes the interest capsule immediately after content selection.

12. The method of claim 1, wherein the user data includes at least one of: communication metadata, application-usage telemetry, media interaction patterns, device data, wellness information, or sensor events.

13. The method of claim 1, further comprising displaying on the client device a human-readable breakdown of the interest capsule and accepting user edits that immediately alter subsequent capsules.

14. The method of claim 1, further comprising transmitting with the capsule an attestation token verifying on-device processing integrity.

15. The method of claim 1, further comprising, in the absence of sufficient historical data, populating an initial interest capsule from explicit user-provided preferences.

16. The method of claim 1, further comprising transmitting gradient updates derived from local training of the machine-learning model via secure aggregation, wherein the gradient-update channel is cryptographically distinct from the interest-capsule channel.

17. A non-transitory computer-readable medium storing instructions that, when executed by a client device, cause performance of the method of claim 1, wherein the instructions are embodied in a software component configured to be integrated into applications.

18. The system of claim 3, wherein the client device encrypts the interest capsule using a key that changes with each refresh interval.

19. The system of claim 3, further comprising a federated-learning coordinator configured to update parameters of the machine learning model without accessing raw user data.

20. The method of claim 1, wherein selecting the digital content includes computing a similarity measure between the interest capsule and respective content vectors, wherein the similarity measure comprises at least one of: cosine similarity, Euclidean distance, Mahalanobis distance, or a learned metric function.

21. The system of claim 3, wherein the client device maintains multiple interest capsules for different content categories or applications.
